(19) United States
(12) Patent Application Publication
(10) Pub. No.: US 2016/0133295 A1
(43) Pub. Date: May 12, 2016

(54) EDITING SYSTEMS

(71) Applicant: H4 Engineering, Inc., San Antonio, TX (US)

(72) Inventors: Christopher T. Boyle, San Antonio, TX (US); Gordon Jason Glover, Corpus Christi, TX (US)

(73) Assignee: H4 Engineering, Inc., San Antonio, TX (US)

(21) Appl. No.: 14/936,500

(22) Filed: Nov. 9, 2015

Related U.S. Application Data
(60) Provisional application No. 62/077,034, filed on Nov. 7, 2014.

(51) Int. Cl. G11B 27/036; G11B 27/34; G06K 9/00

(52) U.S. Cl. CPC G11B 27/036; G06K 9/00744; G06K 9/00718; G11B 27/34

(57) ABSTRACT

An automated video editing apparatus and software are presented. The apparatus is designed to modify automated video recording systems enabling them to collect data used in creating a library of markers observable within the collected data such that the markers may help to identify highlight moments in recorded videos and to create short video clips of the highlight moments. The apparatus and method as described free the user of the burden of reviewing many hours of video recordings of non-events, such as waiting for a sportsman's turn in a competition or waiting for an exciting wave while surfing in the sea.

### CROSS-REFERENCE TO RELATED APPLICATION

This application claims the benefit of U.S. Provisional Application No. 62/077,034 filed Nov. 7, 2014, entitled “EDITING SYSTEM,” which is hereby incorporated by reference in its entirety.

### BRIEF DESCRIPTION OF THE DRAWINGS

FIG. 1 is a flowchart illustrating an automated editing method of the present disclosure.

FIG. 2 is a schematic diagram illustrating an apparatus used to implement the automated editing method of FIG. 1.

FIG. 3 is a screenshot of the staging bay of the editing software as it appears before a file is chosen for editing.

FIG. 4 is a screenshot of the staging bay of the editing software as it appears after a file is chosen for editing illustrating display of a menu for user input regarding highlight criteria.

FIG. 5 is a screenshot of the staging bay of the editing software as it appears after highlights are selected within a file chosen for editing.

FIG. 6 is a schematic diagram of an example tag of the present disclosure.

FIG. 7 is a schematic diagram of an example base of the present disclosure.

### DETAILED DESCRIPTION

The systems and methods provided herein offer solutions to the problems of limited individual time and bandwidth regarding video recordings, particularly those recorded by automated recording devices and systems. As digital memory devices have become capable of storing ever larger video files, the length and resolution of digital video recordings has likewise increased. Even so, the amount of time a person can devote to watching videos has not and cannot increase to a significant extent. Also, the bandwidth for uploading and downloading videos to and from the Internet, including host servers, has not kept pace with the demand of the massive increase of video file information acquired by users. Original high resolution video files can be resaved as low resolution files before uploading to a server where editing takes place. The better approach of the present disclosure is to edit lengthy high resolution videos on user devices and upload only the final result. To achieve this one can create data files that contain important information about the video recording, about the video recording subject's movements during the recording session, and other relevant information. Then, rather than review the high information density video files to identify highlight moments, highlight moments are identified from the corresponding data files (synchronized to the video with matching time stamps). Next, video clips may be generated and approved by the user or the video clips may be further edited by the user.

The following co-owned patent applications which may assist in understanding the present invention are hereby incorporated by reference in their entirety: U.S. patent application Ser. No. 13/801,336, titled “System and Method for Video Recording and Webcasting Sporting Events”, U.S. patent application Ser. No. 14/399,724, titled “High Quality Video Sharing Systems”, U.S. patent application Ser. No. 14/678,574, titled “Automatic Cameraman, Automatic Recording System and Automatic Recording Network”, and U.S. patent application Ser. No. 14/600,177, titled “Neural Network for Video Editing”.

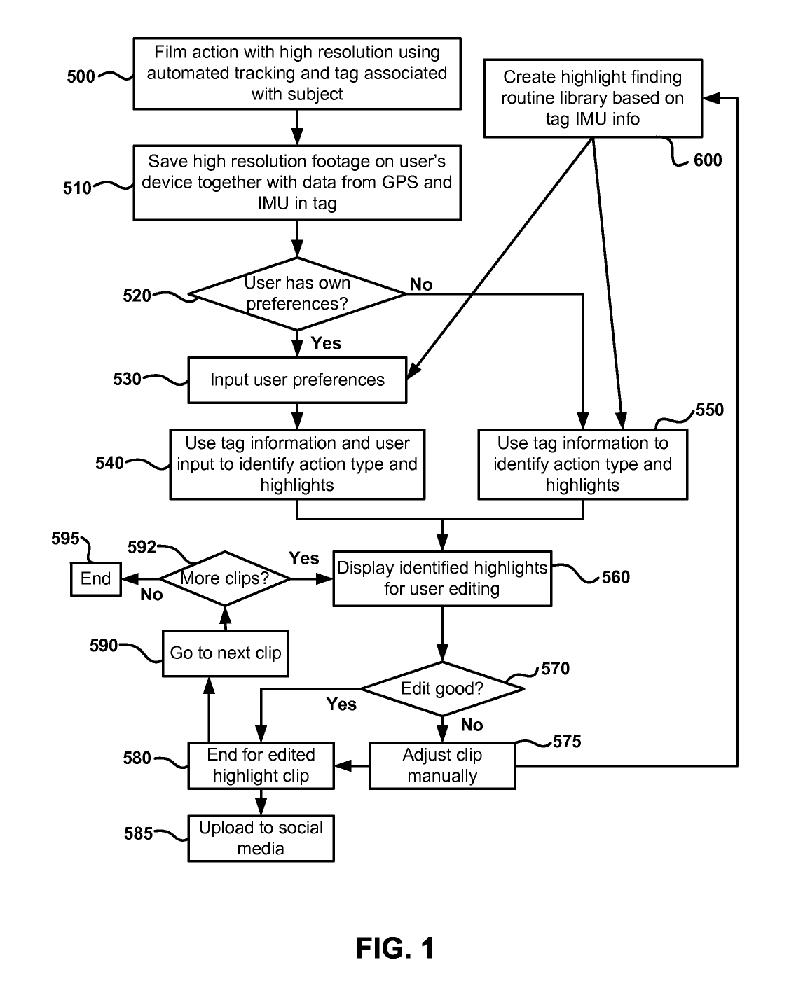

FIG. 1 is a flowchart illustrating an automated editing method of the present disclosure. More particularly, FIG. 1 illustrates an automated editing and publishing method of video footage. Such a method is particularly useful for high resolution videos recorded by an automated recording system. Such systems may record a single take of footage that may comprise three to four hours of footage on a single camera. When a recording system comprises multiple cameras, the amount of footage is multiplied accordingly. The problem of reviewing hours of video footage to find a few highlights may be solved using a remotely located editing service but this approach is expensive and time consuming. The method of the present disclosure overcomes these problems.

Referring to FIG. 1, the user films footage in high resolution in step 500. Usually this is done with automated video recording system using a tag associated with the subject that is tracked by a video recorder, but the editing method could be used without such an automated video recording system or other systems. The recorded footage is saved on the user's device in step 510. As the video is recorded, a tag associated with the subject of the recording and moving with the subject records and transmits data collected by devices in the tag. The devices in the tag include locating devices that provide location data and the time when the data were recorded and devices that provide acceleration and orientation data. Typical locating devices include GPS antennas, GLONASS receivers, and the like. For brevity, Applicant will refer to such locating devices as GPS devices. For the inertial measurement units (hereinafter “IMU”) one such device used in the tag may comprise a nine-degree of freedom IMU that incorporates three sensors: a triple-axis gyro, a triple-axis accelerometer, and a triple-axis magnetometer. The data recorded by the devices in the tag are added to a data file created from the data stream and saved in step 510. The data generated by devices in the tag at least embody herein a “first data stream”. The data recorded by the devices may also be used to compute velocities and distance traveled along a trajectory which may be also added to the data file and saved in step 510.

It is important to realize that GPS data are transmitted typically at a rate of five Hertz in systems using current widely available commercial technology. Even though IMU data are generated much more frequently, the IMU data need not be transmitted at this higher frequency. IMU data are generated at 200 Hz frequency and are downsampled to 5 Hz. This, effectively imposes, a filter on the inherently noisy IMU data.

The video files and data files (which may comprise multiple data streams and data entries by way of user input as discussed herein) may be separate or may be generated and saved originally as a single file together (or combined in a single file of video and metadata). Nevertheless, the following description will consider the video and data files as separate; those with ordinary skill in the art will understand that while there are practical differences between these situations, they are not essentially different.

The data recorded by the tags comprises tag identifiers. The tag identifiers are important in a system where multiple tags are used at the same time, whether or not there are also multiple recorders. One of the tasks that the editing process of the present disclosure may include is naming the highlight clips; when there are multiple tags and subjects, some of the metadata may be the name of each subject associated with their tag and the tag identifier permits the editing software to name the highlight clips such that the file name includes the subject's name. Alternatively, the subject's name may appear in the video clip. Also each subject may have their own individualized access to the edited clips and the clips may be put in a user accessible folder or account space.

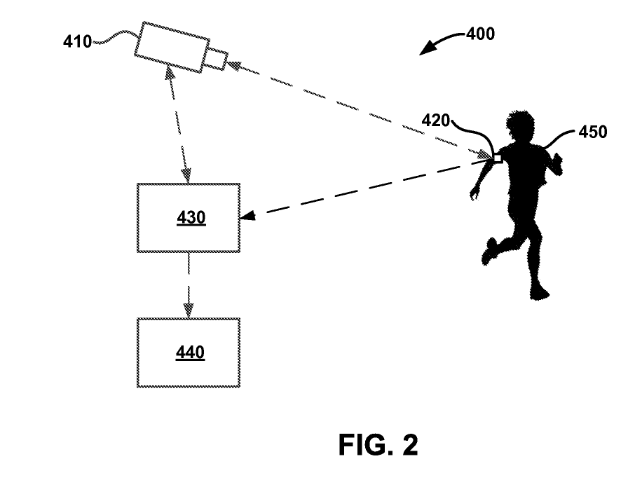

The data files used by the editing process of the present disclosure may also comprise a second data stream, generated in the base (see FIGS. 2 and 7); the second data stream is generated by computation of the data of the first data stream (for example, by computing velocities and distances traveled) and signal intensities as measured during the reception of transmissions from the tag or tags. In many instances the variations of signal intensities, in conjunction with the transmitted data itself, are highly useful identifiers of highlights. Such is the case, for example, in surfing. Further, the data used in identifying highlights may also comprise metadata obtained by the camera in the process of recording and user input data that may be input in the tag, in the base, or in the editing device.

The next step in the method of FIG. 1 is to allow the user to decide if the user has editing preferences that they want to use to modify the editing process in step 520. If not, the information received from the tag and saved as data are used to identify highlight moments in step 550. This identification is carried out using algorithms or routines that are based on prior analysis of multiple examples of a variety of activities and compiled into a library of highlight identifiers in step 600.

Examples of highlight identifiers may include high velocity, sudden acceleration, certain periodic movements, and they may also include momentary loss of signal. It is important to note that these identifiers are often used in context and not alone by themselves. Identifiers characteristic of a particular activity vary depending on the type of activity. Because of this, identifiers may be used to identify the type of activity that was recorded. The type of activity may also be input by the user. The identifiers may also be applied individually; that is, certain individual characteristics may be saved in a profile of returning users and applied in conjunction with other, generic, identifiers of highlights.

The highlight identifiers are like parts of a data file that is created during filming. The data file created during filming comprises a time-dependent data series (or time sequence) of data coming as data streams from the tag, from the base, and from the camera, arranged within the data file according to time of generation from the start of the recording. Thus, when we take a time-limited part of the data file and limit it so the limited part corresponds to a highlight event that has occurred within the time limits imposed, we create an element of a database of highlight identifiers. When this process is repeated a large number of times, one creates a whole database or library such as the one used in step 600.

There are instances when a subject experiences a highlight moment entirely outside of their control, i.e., an interesting moment occurs while they themselves are not doing anything “interesting”. For example, a pair of dolphins may appear next to a surfer who is quietly waiting for a wave. (An example of such footage may be viewed at https://www.youtube.com/watch?v=HX7bmbz5QQ4). In order to not lose such moments, the tag may be equipped with a user interface specifically provided to communicate that a highlight moment has occurred (refer to FIG. 2 and the corresponding discussion). The information thus generated is added to the data file and the program will take notice and produce a highlight clip accordingly.

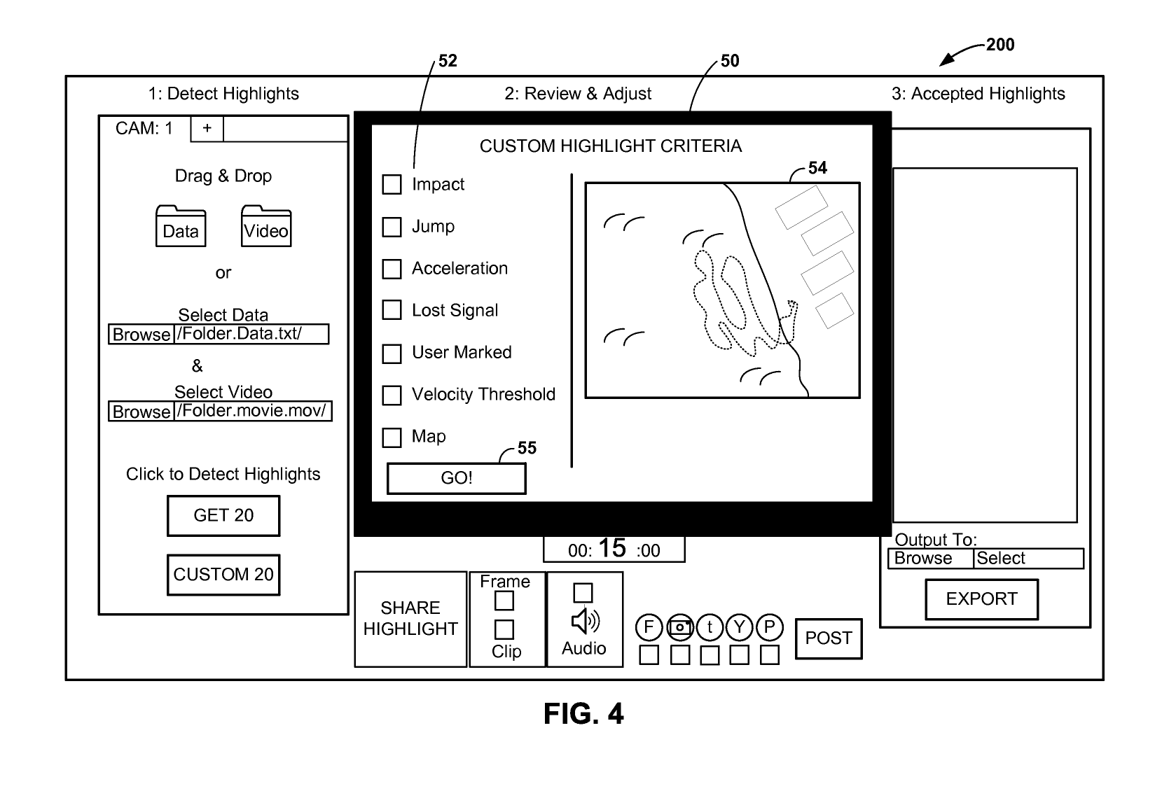

If the user wants to input preferences (“Yes” in step 520), the user may input preferences using, for example, as shown in FIG. 4, a menu of options in step 530. Then the information received from the tag (i.e., the first data stream) and saved in a data file (together with the second data stream, metadata and user input data) is used to identify highlight moments in step 540. This identification is carried out using algorithms or routines that are based on prior analysis of multiple examples of a variety of activities and compiled into a library of highlight identifiers in step 600, but this time the algorithms or routines are modified with the user preferences. An example of user preference is limiting the locations where highlights could have occurred; another one is using a particular clip length, etc.

In step 560 the highlight clips are displayed for further user editing. The user may accept a clip as is or may wish modify it in step 570. If the clip is good, the editing process (at least for that clip) is ended, step 580. Otherwise, the clip may be adjusted manually in step 575. The most common user adjustments are adding time to the clip and shortening the clip. Note that editing actions by the user are used as feedback for creating a better and more personalized highlight finding routine library. More importantly, the user may know about some highlight not found by the software. In such an instance, a new clip may be created by the user that serves as a useful feedback for the improvement of the existing editing algorithms. Once the clip is adjusted, the editing process for the clip being edited is ended, step 580.

The user may upload the edited clip to a server (e.g., for sharing on social media) for viewing by others, step 585.

At this point, the software goes to the next highlight clip in step 590. There may or may not be more highlight clips to edit, this decision is made in step 592. If there are more highlights, the software displays the next clip and the method continues (refer to step 560). If there are no more clips to edit, the editing ends in step 595.

In some versions of the editing software a music clip library is available and music clips may be appended to the video clips. The music clips may be stored on the user's device or may be accessible through the Internet.

Even though the process and method described herein is primarily intended to identify highlights during a known type of activity experience shows that the activity type may be determined from the data collected by the instruments (GPS, IMU) in the tag. The activity type may be an input by the user into the data used to identify highlights along with other important information, such as the name of the subject, maybe a characteristic identifier such as a jersey number of the subject. However, it may be a separate application of the method described herein to identify activity types or subtypes that may not be even known to some subjects.

FIG. 2 is a schematic diagram illustrating the apparatus used to implement the automated editing method of FIG. 1. FIG. 2 illustrates apparatus 400 used for creating the matched, or synchronized, video and data files and for editing the recorded clips into highlight clips. A video recorder 410 is set up to record the activities of subject 450. Subject 450 is associated with tag 420 (e.g., the tag is carried by the subject, has the tag in his/her clothing, has the tag attached to him/her via a strap, etc.). Tag 420 periodically transmits data to base 430. Tag 420 acquires location and absolute time data and orientation data due to its sensors as discussed above. In addition, tag may transmit a “start recording” signal directly to camera 410, thus providing a relative time counting (i.e., a zero time stamp) for the video file(s) recorded by camera 410. Time transmitted to base 430 may be used for time stamping as well if recording is initiated by base 430. Base 430 receives transmissions from tag 420 and may also have other functions, such as transmitting zooming and other control signals to camera 410, measuring the strength (gain, intensity) of the signal received from tag 420, etc. Base 430 may also receive transmissions from other tags. Base 430 may also compute information, such as velocity, distance traveled, etc., based on data received from the tag. Base 430 may save all received (data from the first data stream/tag date) and computed data (data from the second data stream) in data files and/or it may transmit these data to camera 410 where a memory card used to save the digital video recorded by camera 410 may be also used to record metadata. Base 430 may also send feedback to tag 420, including video clips or video streaming. Base 430 may be used to transmit data to editing device 440. Editing device 440 may be a personal computer, a laptop computer, a generic device, or a dedicated device. Editing device 440 preferably has fast internet access. Units 410, 430, and 440 may be separate units, or any two of them may be combined, or all three may be combined in one unit.

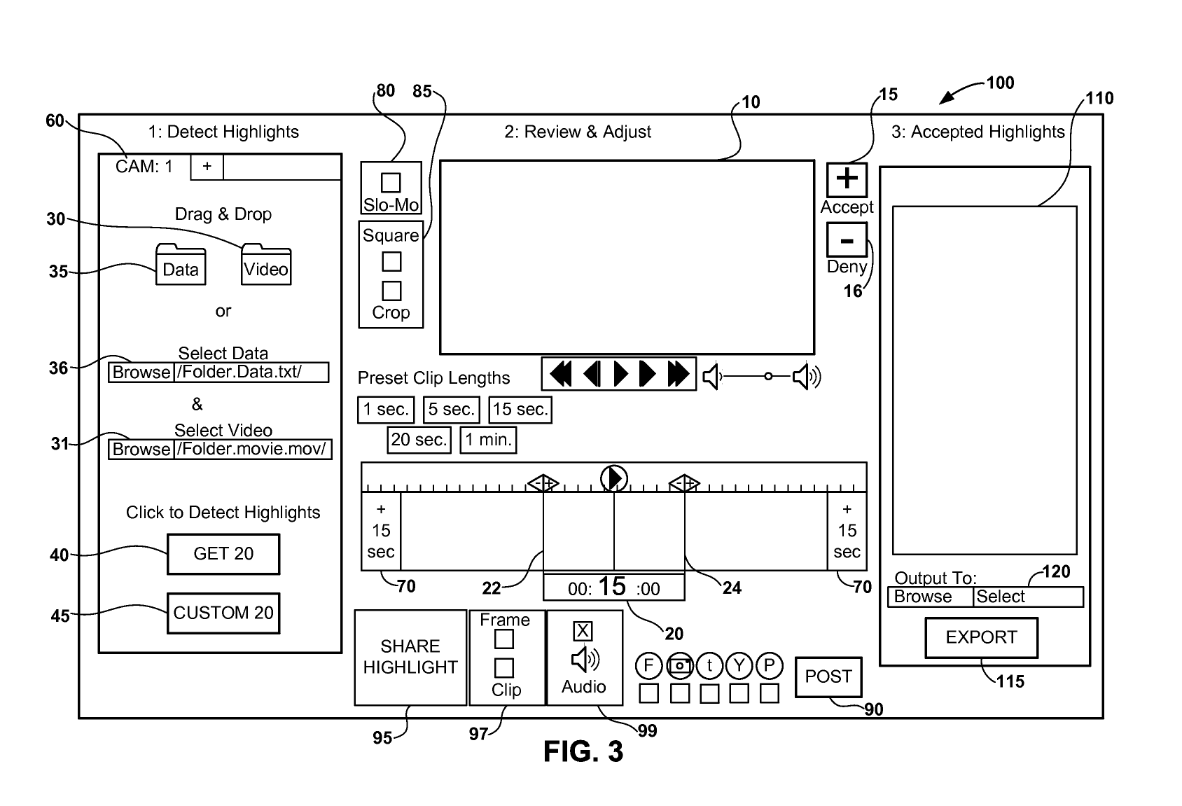

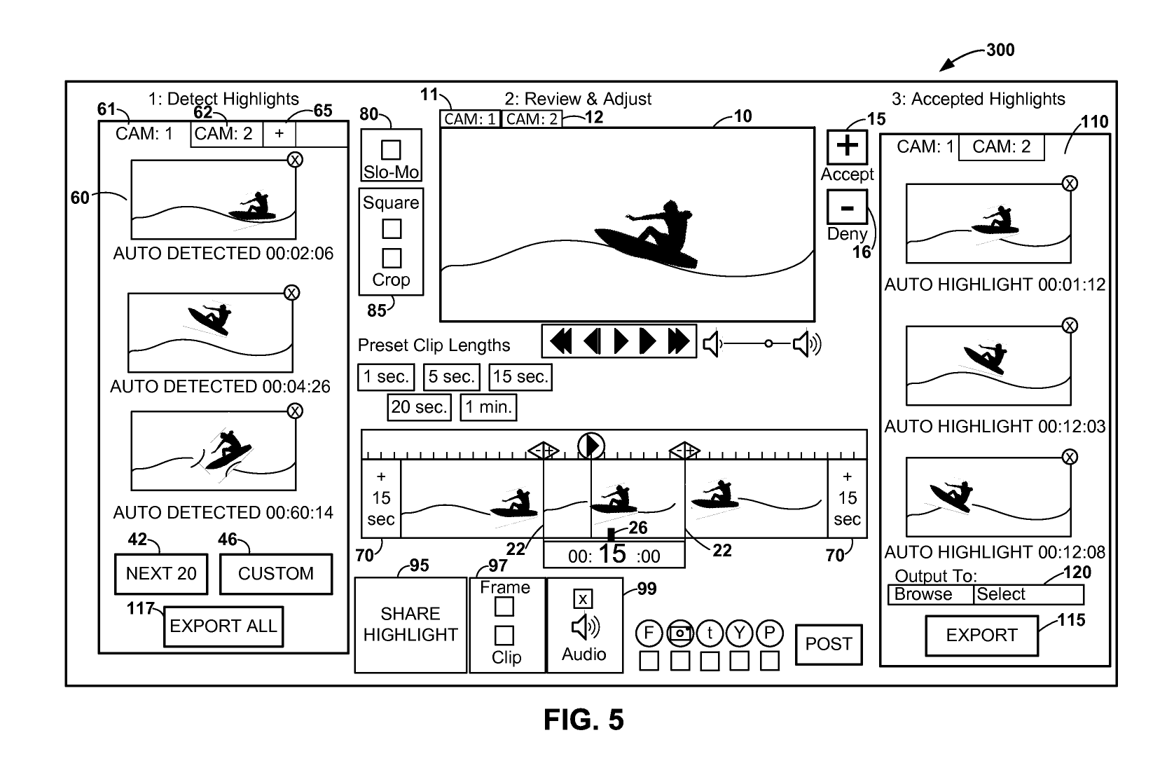

FIG. 3 is a screenshot of the staging bay of the editing software as it appears before a file is chosen for editing. FIG. 4 is a screenshot of the staging bay of the editing software as it appears after a file is chosen for editing illustrating display of a menu for user input regarding highlight criteria. FIG. 5 is a screenshot of the staging bay of the editing software as it appears after highlights are selected within a file is chosen for editing.

With reference to FIGS. 3-5, the systems of the present disclosure systems comprise a staging bay for editing that allows a user to process raw video footage, receive batches of proposed highlights from the raw video footage, accept in bulk or individually adjust the highlights, post to social media, and/or accept reject and then export the accepted/adjusted clips to a folder for easy importation into full editing software. Note that even though selecting a particular button and the like is referred to herein as “clicking” on a button, numerous equivalent methods are available to achieve the same result and choosing alternatives to “clicking” and hardware enabling such alternatives may not be considered departing from the invention hereof. Some of the numbered elements appear in FIG. 3-5 multiple figures and the same number refers to the same element every time.

As shown in FIG. 3, the staging bay shown in screenshot 100 comprises “REVIEW & ADJUST” window 10 in which video shots (frames) corresponding to time stamp 20 can be displayed or videos can be played. The standard PLAY, FAST FORWARD (speed 1), FAST FORWARD (speed 2), REWIND, FAST REWIND, and VOLUME buttons are available for the user (these elements are not numbered to keep the figure less crowded). Also available are buttons for playing a clip of preset length (in the example shown in FIG. 3 these lengths are 1 sec., 5 sec., 15 sec., 30 sec., and 1 min.). These buttons are also not numbered to make the drawing less crowded. Clips may be also delimited by user-adjustable BEGIN and END markers, begin marker 22 and end marker 24, respectively. The user may modify these markers as desired. In the example shown in FIG. 3, time stamp 20 is 15:00 minutes. The time stamp displayed may be relative (time starts with recording ON; refer to FIG. 5) or absolute (time is the best available time obtained, for example, from GPS satellites and adjusted to the time zone where the recording takes place). The data and video files are synchronized, i.e., they have identical time stamps. Time stamps are considered identical if the time stamp difference between corresponding data and video frame is less than 1 second, preferably less than 0.5 seconds. In order to play a video, a video must be selected by drag and drop from available videos in folder 30; relevant data saved in data folder 35 may also be selected and loaded. Alternatively, the files to be loaded may be selected by looking for the files by clicking on buttons 31 or 36; these buttons open directory trees letting the user find files that are not saved in the folders that are reached directly using buttons 30 or 35. Once a video (and, if desired, corresponding data) is/are selected, the user may click on the GET 20 button 40, or on CUSTOM 20 button 45 to start the editing process. In response to clicking on button 40 the automated editing program finds highlights according to preset criteria that may have been modified by the user in previous editing sessions and saved in the host computer where the auto-editing part of the method of the present disclosure is carried out. If the user elects to click on button 45, a menu appears as shown in FIG. 4.

The data may be in text files or in other suitable file formats and may be generated at least in part by the video recorder, such as recorder settings, time and location stamp, etc. In the case of automated cooperative tracking, at least part of the data may come from the tracking device but a part may come from user input, for example the name(s) of the person or persons visible in the video, or the name of the venue where the video was shot. These data are of particular importance for recording systems comprising multiple cameras that may include shots of the same highlight taken from multiple vantage points. Also, in the case of a single camera following different users sequentially, as it may be the case, for example, when filming a skiing event where skiers appear in the camera shot one after the other, the skiers are identified by their individual tags that are used in cooperative tracking and this information needs to become part of the video where the skier who is shown in a particular clip may then be identified in subtitles added to the clip. This enables the user to provide each event participant with video clips of their own activity. Such video clips may be provided online (via an offer to download) or in the form of removable media (DVDs, SD cards, etc.) that may be given to participants right at the venue immediately following the event.

FIG. 4 shows screenshot 200 after a video file has been imported. In FIG. 4, the user pressed the “CUSTOM 20” button 45. The CUSTOM HIGHLIGHT CRITERIA popup window 50 appears in screenshot 200. In popup window 50 the user can select editing parameters from menu 52 to focus highlight finding. In addition, the user may draw a window thereby selecting an area of interest for their session on map 54 displayed along with menu 52. For example, if the video was recorded at a soccer game, the user might select areas close to the gates (say ⅓ or ⅕ of the field) to capture plays nearing goals. In kiteboarding films, the user could select a certain portion of the ocean and ignore time spent on the beach.

FIG. 5 shows a screenshot after highlights have been selected and populated on the left window 60 of screenshot 300. Once the first batch of highlights populates the left window, the user can either play and accept clips directly from column 60 on the left or simply accept them all and immediately send them to the accepted folder. In screenshot 300, the user has taken advantage of the option of using a second camera by clicking on button 62 and the highlights displayed below this button are from footage taken by a second camera (CAM: 2). To display highlights from the other camera, the CAM: 1 button 61 is used. To add highlights from a third camera one clicks on button 65 (displaying a “+” icon). In the example shown in FIG. 5, the default is to show 20 highlights at a time and by clicking on button 42 one can call up the next 20 highlights if there are more highlights. One can use the custom button 46 to display other numbers of highlights. The user may click on button 117 to EXPORT ALL highlights, i.e., to approve them as a batch.

If a particular file needs adjustment or the user wants to share highlight clips on social media (Facebook post, YouTube, etc.), a user can double click or drag a video clip to the middle adjustment bay 10, denoted as REVIEW & ADJUST. The adjustment area allows a user to see the point where the data says the highlight is, marker 26, and a fixed amount of time before and after, delimited by BEGIN and END markers 22 and 24, respectively. The user can adjust the length and position of the highlight easily by changing the position of the markers. If the user wants to see a little more footage before or after the clip, they may press one of the +15 s buttons 70 which will display 15 seconds of footage before or after the presently displayed footage, depending on which side of the screen button 70 is pressed. The user may click on the ACCEPT button 15 to accept once satisfied and the clip goes into the right column 110 (accepted highlights). Once in the right column, the clips wait for the user to export everything to the accepted folder using the EXPORT button 115. One also can share a highlight not yet approved using button 95, and select a frame or a clip for sharing by pressing button 97. A user can call up a music matching routine and listen to audio playing with the clip using button 99. The edited clip may be accepted (button 15), or rejected altogether (button 16). The SLO-MO 80 (slow motion) and the CROP 85 buttons are self-explanatory and aid the editing work.

The video clips may be loaded into a project template that has known cut points that align with musical transitions to either slightly adjust the clip lengths such that they align with the predetermined musical transitions and/or auto align the “highlight peak” represented by marker 26 in FIG. 5 (the marker that is above the number “15” and aligned with the surfer on the video footage) such that the data determined peak of the highlight aligns with a musical transition and the beginning and end of the highlight clip automatically adjusts such that the time length of the clip lines up with the fixed time between musical transitions.

Screenshots 100, 200, and 300 of FIGS. 3-5 illustrate an example workflow. The system may be described in two parts: 1) a process that identifies relative time stamps and 2) a dashboard that manipulates video files based on the identified relative timestamps. By relative timestamp, what is meant is time in seconds where t=0 is the start of the first video file and time count continues to run even when camera is paused. If a camera started recording, recorded for 3,000 seconds, stopped for 15 seconds, and recorded again for 4500 seconds before finishing recording, the total time would be 7515 seconds. The synchronization of the data time and video time (i.e., that both have the same relative time stamps) may be achieved by using the tag to transmit a start video signal to the base with the base responding by turning the video recorder on. Alternatively, there may be direct communication between the tag and the camera. It is also possible that the base receives information about starting video from the camera and uses this information to begin relative time for the data coming from the tag.

In addition to the functions and editing steps described above, the software is also designed to rank the highlights (and the corresponding video clips) such that clips that are likely to be of significant interest are ranked higher, and when only some clips are pushed out to social media, the clips so published are the most interesting ones. A basis of this ranking is user input; when a highlight is due to the user engaging a highlight button, it is usually important. The rankings are further influenced by the numbers, such as measured acceleration, computed speed, height and duration of a jump, and the like. In the case when a system is recording a sequence of competition performances, ranking may be altered by adding extra points to known star performers.

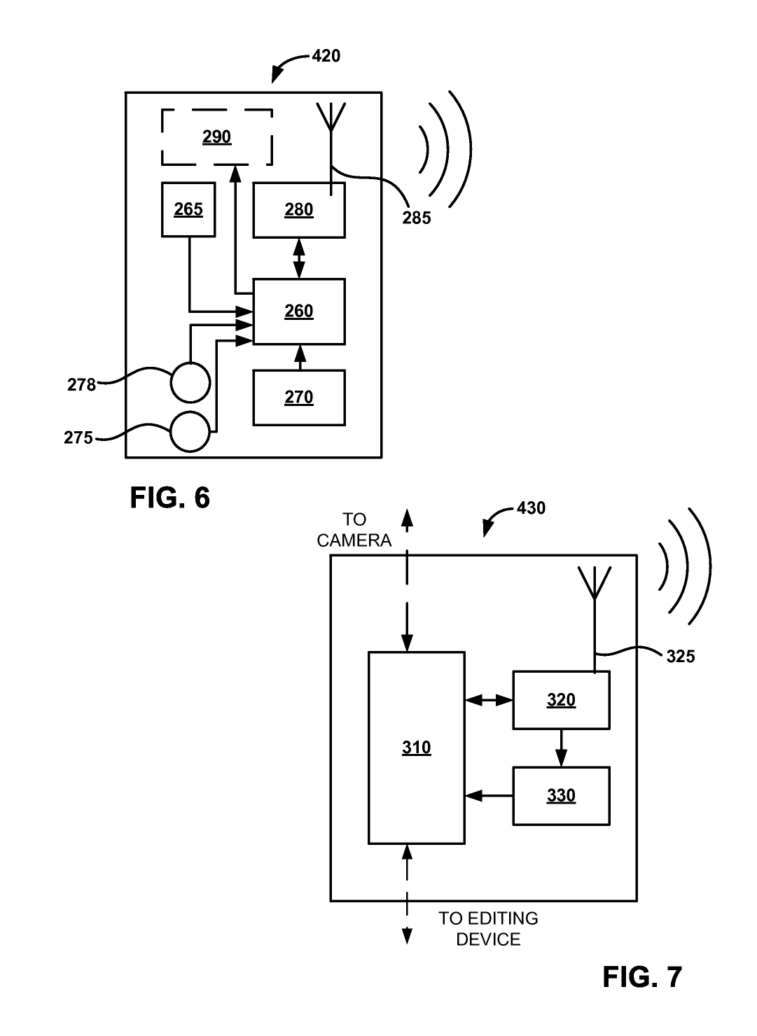

FIG. 6 is a schematic diagram of an example tag of the present disclosure. FIG. 6 shows tag 420 shown in FIG. 2. Tag 420 comprises transceiver 280 coupled with antenna 285, microcontroller 260 that receives data both from GPS antenna 265 and IMU 270. Microcontroller 260 may also receive highlight alert information from user operated button 275 and subject initiated “start recording” commands after subject 450 (FIG. 2) engages manual input 278. The “start recording” command is also transmitted to base 430, providing information for synchronizing video and data files. Finally, tag 420 may also comprise optional visual feedback (display) device 290. Microcontroller 280 creates the information data packets that are broadcast to base 430 and to camera 410 (see FIGS. 2 and 7).

FIG. 7 is a schematic diagram of an example base of the present disclosure. Base 430 comprises microprocessor 310 configured to receive data from transceiver 320 which itself receives data packets sent by tag 420 via antenna 325. Device 330 is included to measure the signal intensity level of each transmission received by transceiver 320 from tag 420. The signal intensity data measured need not be absolute, rather the interest is in observing sudden relative intensity changes. For example, signal intensity will generally increase if the subject with the tag approaches the base and will decrease when the distance between the tag and base becomes larger. These changes are gradual and do not influence the highlight identification. When, however, there is a sudden increase in the signal intensity because the subject stands up on a surfboard and thus the subject's tag is in a better position to transmit (compared with a subject that is paddling), this is a sudden change and signifies the likelihood that a highlight moment, such as catching a wave, will follow imminently. This device may not be always used but for some activities the data provided by device 330 is important for highlight identification. The results measured by device 330 are an additional input for microprocessor 310 and are added to the data packets received by transceiver 320. Base 430 also comprises communication ports (not shown) to enable microprocessor 310 to communicate with camera 410 and editing device 440 (see FIG. 2). These communications may be wireless. The communication with editing device 440 may be indirect through camera 410 if the data output is saved in the camera memory card.

There are transceivers shown both in FIG. 6 and FIG. 7, i.e., both in the tag and in the base. Transceivers are most commonly understood being devices that transmit and receive radio signals. However, in this Application a transceiver may be understood more broadly as a device that transmits and/or receives communication.

Using a process that provides relative timestamps, the editing workflow may have the following additional features:
1. Export to folder: A window may pop up asking if the user would like the video file type output to be the same as the input or give various other options.
2. Social Media Sharing: Users may share individual clips directly to their various social media accounts from the “staging bay”.
3. The user may have a folder of clips ready for easy importation into their editing software of choice. In Applicant's experience, the described highlight finding and staging reduces the time for making a video clip by about 80 percent.
4. A “+” button 62 may be present to add additional camera footage. This makes it easier to edit and link video files captured at the same time of the same event. Each camera either shares a data file or has its own data file (but all data files share the absolute time stamp due to GPS information). Corresponding video and data are linked with a relative timestamp (as described previously) while data files originating from different tags are linked by an absolute timestamp for proper synchronization. In the case where multiple tags are used indoors where GPS signal is unavailable, care must be taken to synchronize their relative time stamps. This may be done by actions as simple as touching tags to one another or by sending a master signal from the base to all other devices (cameras and tags).
5. All recorded angles may be shown in the editor bay at the same time so they can be watched simultaneously. A user may select which angle or angles of the highlight they want and then when those are created as files in the folder they may be give a name such as “Highlight 003 angle 001”.

It is important to note that even though in other places we are describing measuring intensity of the incoming radio signal, other electromagnetic or even sound transmission may be possible to use. The changing intensity of those signals as, for example, a surfer paddles close to the water first and the stands up on the surf board, could be measured and analyzed with the same or similar usefulness for automated editing.

The methods described in this Application could be used also to analyze the data file, the data from the IMU and GPS devices (a first data stream) and from measured signal intensity (strength) and from computations executed in the base (a second data stream), combined with user input data and metadata in real time for editing and thus to identify highlights very shortly after they occur (while the activity of the filmed subject is still continuing). This is based on the possibility of nearly (quasi) real time transmission of the data to the editing device 440 of FIG. 2 configured to do the analysis based on library data bank. The library data could be highly personalized for experienced users but the use of general library data banks would make it possible for all users to have quasi real time highlights identified. If the subject is also equipped with a device capable of displaying the highlight video (see display 290 in FIG. 6), which does not require any more capability than that of a smart phone, then the subject could immediately approve the edit and share it via social media without much interruption of the activity that is filmed. Clearly, user input identifying a highlight would also be possible to follow up with creating the highlight clip, approving it, and pushing it out into social media.

Different embodiments, features and methods of the invention are described with the aid of the figures, however the particular described embodiments, features and methods should not be construed as being the only ones that constitute the practice of the invention and the described embodiments, features and methods are in no way substitutes for the broadest interpretation of the invention as claimed.

What is claimed is:

1) An automated video editing method, said method comprising the steps of:
a) recording a video of a subject;
b) creating a time stamp of the start of recording;
c) storing the recording of the subject in a video file together with metadata;
d) during recording of the subject periodically receiving transmissions of a first data stream from a tag, the first data stream comprising acceleration, orientation, and location data associated with the subject, including a time of generation of the acceleration, orientation, and location data;
e) creating a second data stream by executing computations on the first data stream and by measuring changes in the relative intensity of the received transmissions of the first data stream;
f) creating a data file comprising a time-dependent data series of the first data stream, the second data stream, and the metadata, arranged within the data file according to time of generation from the start of the recording;
g) using characteristic time-dependent changes in the data file as criteria signifying activity changes of the subject for a given activity type to identify highlights in the video file;
h) automatically editing the video file to create video clips timed and sized such that each video clip includes at least one of the identified highlights.

2) The automated video editing method of claim 1, further comprising the step of ranking highlights by the likely interest level of viewers based on the characteristic time-dependent changes in the data file that are used to identify the highlights.

3) The automated video editing method of claim 1, further comprising the step of automatically identifying the activity type of the subject based on the data file.

4) The automated video editing method of claim 1, further comprising the steps of detecting a user input created by an input device usable by the subject, storing the user input as user input data in the data file, and using the user input data to identify a highlight.

5) The automated video editing method of claim 1, further comprising the step of appending music to a video clip.

6) A video editing system that edits a video of a subject into video clips, said system comprising:
a) a video recorder that records video files and configured to be communicatively coupled with a base;
b) a tag associated with the subject and configured to periodically obtain and to transmit location, acceleration, and orientation data;
c) the base configured to receive a signal carrying the data transmitted from the tag, to compute additional data from the received data, to create a data file comprising said data as well as user input and other metadata, and to synchronize the data file with the video file;
d) an editing device configured to store the video file, the data file, and a library of highlight markers wherein said markers, in certain combination, are characteristic of highlights of certain activity types; the editing device also configured to search the data file for characteristic combinations of highlight markers and to determine highlight times; and the editing device also configured to create video clips that comprise parts of the video file recorded around the highlight times.

7) The video editing system of claim 6, said base configured to periodically detect an intensity of the signal received from the tag and to add the intensity data to the data file.

8) The video editing system of claim 6, said tag comprising a subject input device configured to create a highlight alert transmitted to the base and added to the data file and stored in the editing device; the editing device configured to create a video clip that comprises parts of the video file recorded around the highlight alert time.

9) The video editing system of claim 6, further comprising an editing device configured to display the automatically edited clips and configured to have user controls permitting changing the timing and the duration of the edited video clips and to accept or reject the video clips.

10) The video editing system of claim 9, further comprising an editing device configured to rank the edited clips according to the likely viewer interest in the edited clips.

11) The video editing system of claim 9, the editing device configured to append music clips from a music database to the video clips.

12) An automated video editing method, said method comprising the steps of:
a) recording a video of a subject;
b) creating a time stamp of the start of recording;
c) storing the recording of the subject in a video file;
d) during recording of the subject periodically receiving by a base transmissions comprising acceleration, orientation, location, and time data from a tag associated with the subject;
e) using the base to compute derived data from the data received from the tag as these data are received;
f) creating a data file comprising the data received from the tag, derived data computed by the base, user input data, and metadata obtained in the process of recording the video and received from the video recorder, and arranging the data within the data file into a time sequence according to the time when obtained and starting at the time of the start of the recording;
g) storing a database of characteristic changes in a time sequence of data as criteria to identify activity changes of the subject for a given activity type and to identify highlights in the video file;
h) using the criteria stored in the database to identify activity changes of the subject and to identify highlights in the video file;
i) automatically editing the video file to create video clips timed and sized such that each video clip includes at least one of the identified highlights.

13) The automated video editing method of claim 12, also comprising the step of creating a ranking of the clips according to likely interest of viewers.

14) The automated video editing method of claim 12, also comprising accepting user input preferences prior to automatically editing the video file.

15) The automated video editing method of claim 12, also comprising enabling user input to modify the automatically edited clips.

16) The automated video editing method of claim 15, also comprising adding user input to the database of characteristic changes in the time sequence of data used to identify highlights.
